(19) United States
(12) Patent Application Publication
(10) Pub. No.: US 2018/0211406 A1
(43) Pub. Date: Jul. 26, 2018

(54) Image processing method and device for unmanned aerial vehicle

(71) Applicant: SHANGHAI HANG SENG ELECTRONIC TECHNOLOGY CO., LTD, Shanghai (CN)

(72) Inventors: Yu Tian, Kunshan (CN); Wenyan Jiang, Kunshan (CN)

(73) Assignee: SHANGHAI HANG SENG ELECTRONIC TECHNOLOGY CO., LTD

(21) Appl. No.: 15/857,621

(22) Filed: Dec. 29, 2017

(30) Foreign Application Priority Data
Jan. 23, 2017 (CN) 201710050288.7

(51) Int. Cl. G06T 7/70; B64C 39/02; G06T 7/20; G06K 9/00

(52) U.S. Cl. CPC G06T 7/70; B64C 39/024; B64D 2045/0085; G06K 9/00718; B64C 2201/123; G06T 7/20

(57) ABSTRACT

An image processing method and device are provided. The image processing method includes steps of: receiving image data from the UAV, wherein the image data is associated with one or more identifications related to the UAV; parsing the image data to obtain the one or more identifications; and classifying images into a sub image library corresponding to the one or more identifications of a first image library according to the one or more identifications parsed. The image processing method and device for the UAV according to the preferred embodiments of the present invention are capable of classifying images obtained by the UAV clearly, so as to facilitate operations of checking, downloading and etc for the user.

### CROSS REFERENCE OF RELATED APPLICATION

The present application claims priority under 35 U.S.C. 119(a-d) to CN 201710050288.7, filed Jan. 23, 2017.

### BACKGROUND OF THE PRESENT INVENTION

### Field of Invention

The present invention relates to the field of images, and more particularly to an image processing method and device for an unmanned aerial vehicle (UAV).

### Description of Related Arts

Unmanned Aerial Vehicle (UAV) is an unmanned aerial vehicle controlled by a radio remote control device or an onboard computer program-controlled system. Compared with manned aircraft, the UAV is simple in structure and low in cost, and playing an important role both in military and civil fields.

UAV equipped with high-resolution digital cameras, light optical cameras, high-definition video cameras, etc., is capable of shooting in the air under a condition of wireless remote control. UAV aerial photography has advantages of high clarity, and flexibility and is now widely used in various fields of military, civil and daily life.

Under normal circumstances, images taken by the UAV can be returned to the control terminal of the ground in real time, but the picture returned is not effectively classified and thus the operations of the user is extremely inconvenient.

### SUMMARY OF THE PRESENT INVENTION

The present invention provides an image processing method and device for an unmanned aerial vehicle (UAV) which is capable of classifying images obtained by the UAV clearly, so as to facilitate operations of checking, downloading and etc for the user.

Firstly, the present invention provides an image processing method for an unmanned aerial vehicle (UAV), comprising steps of:

receiving image data from the UAV, wherein the image data is associated with one or more identifications related to the UAV;

parsing the image data to obtain the one or more identifications; and

classifying images into a sub image library corresponding to the one or more identifications of a first image library according to the one or more identifications parsed.

Secondly, the present invention provides image processing method for an unmanned aerial vehicle (UAV), comprising steps of:

obtaining image data;

obtaining one or more identifications related to the UAV when the image data is obtained;

associating the one or more identifications with the image data; and

sending the image data associated with the one or more identifications to a ground terminal.

Thirdly, the present invention provides image processing device for an unmanned aerial vehicle (UAV), comprising:

a receiving module configured to receive image data from the UAV, wherein the image data is associating with one or more identifications related to the UAV;

a parsing module configured to parse the image data to obtain the one or more identifications; and

a classifying module configured to classify images into a sub image library corresponding to the one or more identifications in a first image library according to the one or more identifications parsed.

Fourthly, the present invention provides an image processing device for an unmanned aerial vehicle (UAV), comprising:

a first obtaining module configured to obtain image data;

a second obtaining module configured to obtain one or more identifications related to the UAV when the image data is obtained;

an configured to associating the one or more identifications with the image data; and

a sending module configured to send the image data associating with the one or more identifications to a ground terminal.

The image processing method and device for the UAV according to the preferred embodiments of the present invention associates the image data obtained by the UAV with the one or more identifications related to the UAV; and classifies the images obtained by the UAV according to the one or more identifications and the preset classification properties, so as to classify images obtained by the UAV clearly to facilitate operations of checking, downloading and etc. for the user

### BRIEF DESCRIPTION OF THE DRAWINGS

In order to illustrate the technical solution in the preferred embodiment of the present invention more clearly, the accompanying drawings applied in the preferred embodiment of the present invention are briefly introduced as follows. Apparently, the accompanying drawings described below are merely examples of the preferred embodiments of the present invention. One skilled in the art may also obtain other drawings based on these accompanying drawings without creative efforts.

FIG. 1 is a schematic view of an image transmitting system for an unmanned aerial vehicle (UAV) according to a first preferred embodiment of the present invention.

FIG. 2 is a flow chart of an image processing method for the UAV according to the preferred embodiment of the first present invention.

FIG. 3 is a flow chart of the image processing method for the UAV according to a second preferred embodiment of the present invention.

FIG. 4 is a flow chart of the image processing method for the UAV according to a third preferred embodiment of the present invention.

FIG. 5 is a block diagram of an image processing device for the UAV according to the first preferred embodiment of the present invention.

FIG. 6 is a block diagram of the image processing device for the UAV according to the second preferred embodiment of the present invention.

FIG. 7 is an exemplary structural schematic view of hardware architecture of a computing device capable of implementing at least one portion of the image processing method and device for the UAV according to a preferred embodiment of the present invention.

### DETAILED DESCRIPTION OF THE PREFERRED EMBODIMENT

In order to make the objectives, technical solutions and advantages of the preferred embodiments of the present invention more comprehensible, the technical solutions in the embodiments of the present invention are clearly and completely described combining with the accompanying drawings in the preferred embodiments of the present invention. Apparently, the preferred embodiments are only a part but not all of the embodiments of the present invention. All other embodiments obtained by people skilled in the art based on the preferred embodiments of the present invention without creative efforts shall fall within the protection scope of the present invention.

It is worth mentioning that in the case of no conflict, the preferred embodiments in the present invention and the characteristics in the preferred embodiments may be combined with each other. The present application will be illustrated in detail below with reference to the accompanying drawings and the preferred embodiments.

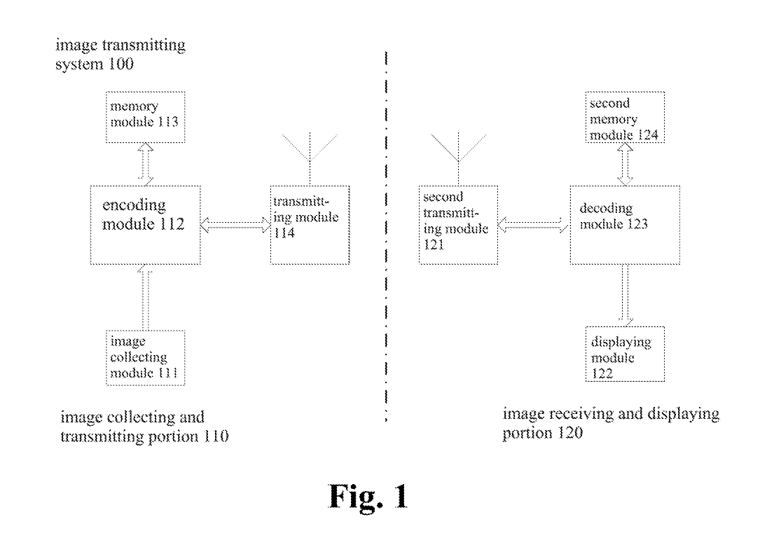

FIG. 1 is a schematic view of an image transmitting system for an unmanned aerial vehicle (UAV) according to a first preferred embodiment of the present invention. The image transmitting system 100 comprises: an image collecting and transmitting portion 110 provided on an unmanned aerial vehicle (UAV) and an image receiving and displaying portion 120 on a ground terminal. The image collecting and transmitting portion 110 digital compression processes information of an image captured, and then wirelessly transmits to the image receiving and displaying portion on a ground terminal. The ground terminal demodulates and decodes signals received and displays the signals on a display device to achieve a function of transmitting the digital image remotely in real time.

According to functional requirements, the image collecting and transmitting portion 110 comprises: an image collecting module 111, an encoding module 112, a memory module 113 and a transmitting module 114; wherein the modules mentioned above are capable of achieving functions of shooting, encoding and transmitting by an airborne portion. The image collecting module can be, for instance, a high-resolution digital camera, a high-definition video camera and etc. The encoding module 112 can adopt any image encoding scheme. The memory module 113 can be volatile or non-volatile memory in any form. The transmitting module 114 is capable of sending radio signals. The image receiving and displaying portion 120 comprises: a second transmitting module 121, a displaying module 122, a decoding module 123 and a second memory module 124; wherein the modules mentioned above is capable of achieving functions of receiving, decoding and displaying image. The transmitting module 121 is capable of receiving radio signals. The displaying module 122 may be any form of display device such as a liquid crystal display and an LED display. The decoding module 123 can adopt any forms of image decoding scheme, and the decoding scheme is corresponded to the encoding scheme adopted by the encoding module 112. The second memory module 124 may be any form of volatile or non-volatile memory.

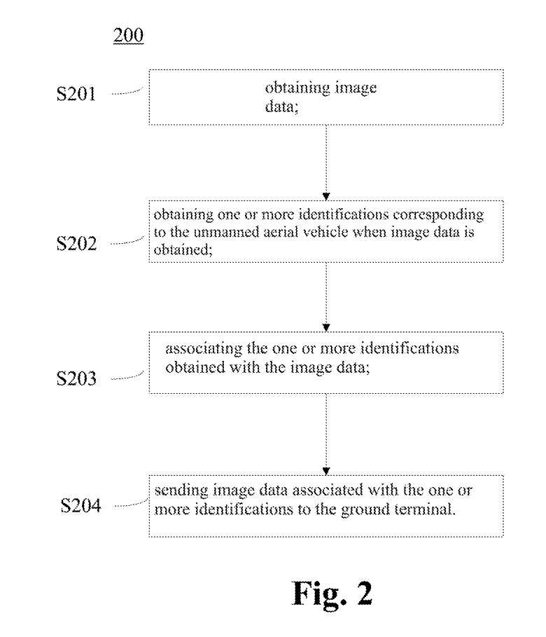

FIG. 2 is a flow chart of an image processing method for the UAV according to the preferred embodiment of the first present invention. The image processing method can be performed on a side with the unmanned aerial vehicle (UAV).

Step S201: obtaining image data by an unmanned aerial vehicle. According to a preferred embodiment of the present invention, the unmanned aerial vehicle takes images by a high-definition video camera and obtains corresponding image data. According to the preferred embodiment of the present invention, the unmanned aerial vehicle is capable of obtaining images by communicating with other air vehicles or ground terminal.

Step S202: obtaining one or more identifications corresponding to the unmanned aerial vehicle when image data is obtained. The one or more identifications may be information related to status of the image or the unmanned aerial vehicle, comprising, but not limited to, a time point, a waypoint, a flying height, a flying posture, a flying speed, a distance from a destination, and the like. For example, the time point can be obtained by reading a clock of the UAV system, and the time point can be based on system time or network time of the UAV while the image is taken. The waypoint of the UAV may be obtained, for example, by any positioning technique such as GPS (Global Positioning System) positioning, base station positioning, WiFi (Wireless Fidelity) positioning, IP (Internet Protocol) positioning, Bluetooth positioning, acoustic positioning, scene reorganization positioning, and etc., or by communicating with any other positioning system. The waypoint of the UAV can be based on the city, district, street and other information of a location of the UAV as determined by the positioning technology when the image is taken. A flight altitude of the UAV can be obtained by, for example, a UAV on-board digital barometer, radar or satellite positioning. The flight attitude of the UAV can be obtained, for example, by a UAV on-board electronic gyroscope. The flight speeds of the UAV can be obtained, for example, by ultrasonic velocity profile measurement or airspeed tube or micro differential pressure wind velocity sensors. The distance to the destination can be obtained, for example, by radar distance measurement or satellite distance measurement. In addition, the one or more identifications may further comprise a flight abnormality indicator. The flight abnormality indicator may indicate that the image is taken by the UAV in an abnormal situation, wherein the abnormal situations may include, but are not limited to, abnormal jitter, abnormal speed, abnormal flight path, and the like. The flight abnormality indicator can be obtained from the data sensed by the UAV airborne sensor. In addition, the one or more identifications may further comprise an abnormal number for indicating which anomaly is and an image number of the image taken during the anomaly for indicating an order of the images taken.

Step S203: associating the one or more identifications obtained with the image data by the UAV. According to a preferred embodiment of the present invention, the UAV write the one or more identifications at a preset position of the image data, such as a frame header, a reserved field and etc. According to another preferred embodiment of the present invention, an associated file corresponding to the image is set, in such a manner that the UAV is capable of storing the one or more identifications in the associated file of the image. According to another preferred embodiment of the present invention, the UAV is capable of storing the one or more identifications in a database corresponding to the image. The database may be stored locally at the UAV or at a ground terminal associated with the UAV; or stored at any other storage device can be remotely communicated with the UAV or the ground terminal thereof. According to another preferred embodiment of the present invention, the UAV is capable of writing the one or more identifications into extended attributes corresponding to the image.

According to a preferred embodiment of the present invention, the flight abnormality indicator may be associated with all images obtained in abnormal conditions, i.e., all the images obtained in the abnormal conditions are associated with the flight abnormality indicator. According to another preferred embodiment of the present invention, the flight abnormality indicator may be associated with only images obtained at the beginning and end of the flight anomaly; i.e., for example, the images obtained at the beginning of the flight anomaly is associated with an flight beginning abnormality indicator; and the images obtained at the end of the flight anomaly is associated with an flight end abnormality indicator.

Step S204: sending image data associated with the one or more identifications to the ground terminal.

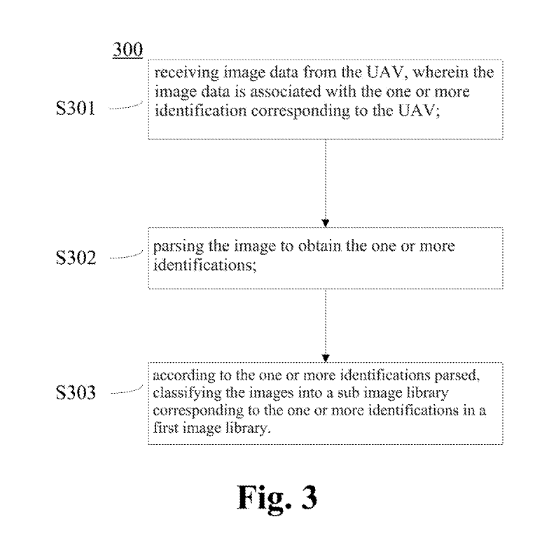

FIG. 3 is a flow chart of the image processing method 300 for the UAV according to a second preferred embodiment of the present invention. In one embodiment, image obtained by the UAV, aerial image for example, comprises static images and motion videos.

As shown in FIG. 3, step S301: receiving image data from the UAV by the ground terminal, wherein the image data is associated with the one or more identification corresponding to the UAV. According to a preferred embodiment of the present invention, the one or more identifications can be utilized for classifying the images received. Associating manner of the image data and the one or more identifications comprises, but not limited to, writing the one or more identifications in a preset position of the image data; storing the one or more identifications to a file associated with the image; storing the one or more identifications in database corresponding to the image; and writing the one or more identifications in the extended attributes corresponding to the image.

Step 302: parsing the image to obtain the one or more identifications comprising, but not limited to, obtaining the one or more identifications from the preset position of the image data; obtaining the one or more identifications from the file associated with the image; obtaining the one or more identifications from the database corresponding to the image; and obtaining the one or more identifications from the extended attributes corresponding to the image.

Step S303: according to the one or more identifications parsed, classifying the images into a sub image library corresponding to the one or more identifications in a first image library. In the step S202, the one or more identifications parsed comprise, the time point, the waypoint, the flying height, the flying posture, the flying speed, the distance from the destination, the flight abnormality indicator and etc. In a preferred embodiment of the present invention, according to the one or more identifications, the images can be classified based on classification property. In one embodiment, the classification property refers a single indicator, in such a manner that images having identical identification are classified in a sub image library. According to a preferred embodiment of the present invention, the classification property refers to one or more separate values, in such a manner that images having identifications containing the one or more separate values are classified in a sub image library. In another preferred embodiment, the classification property refers to a range of a certain value, in such a manner that images having identifications within the range is classified in a sub image library. According to a preferred embodiment, the classification property refers to a threshold, in such a manner that images having identifications with a threshold above or below the threshold are classified in a sub image library.

According to a preferred embodiment, if the flight abnormality indicator comprises a flight beginning abnormality indicator and a flight end abnormality indicator, the ground terminal is capable of determining an image associated with an abnormality condition according to the flight beginning abnormality indicator and the flight end abnormality indicator which are parsed and the image transmission sequence, and the images are classified into a sub image library. According to a preferred embodiment of the present invention, if the flight beginning abnormality indicator is parsed, a series of images containing the abnormality number from a beginning of the flight abnormality to an end of the flight abnormality is classified into a flight abnormality sub library. According to a preferred embodiment of the present invention, abnormal images are sequenced based on image numbers, so as to display images taken during the abnormal conditions.

According to a preferred embodiment of the present invention, the first image library is an unloaded library. The first image library comprises one or more sub image libraries, each of which refers to a different classification attribute. If the one or more identifications associated with the image match the classification properties of a particular sub image library, the image is sorted into the sub image library. According to a preferred embodiment of the present invention, the classification attribute of the sub image library refers to a date, a time of the date, a moment of the date, and etc. If point-in-time information of an image is on the date, the time of the date, or the moment of the date, the image is sorted into the sub image library. According to a preferred embodiment of the present invention, the classification attribute of a certain sub image library refers to a city, a street, and etc. If the waypoint information of the image is in the city or the street, the image is sorted into this sub image library. According to a preferred embodiment of the present invention, the classification attribute of a sub image library refers to a route. If the waypoint information of the image is on the route, the image is sorted into the sub image library.

According to a preferred embodiment of the present invention, images are displayed based on the classification mentioned above. According to another preferred

embodiment of the present invention, the images sorted are displayed more intuitively by accompanying with other information such as flight routing information of the UAV, satellite maps and/or weather conditions.

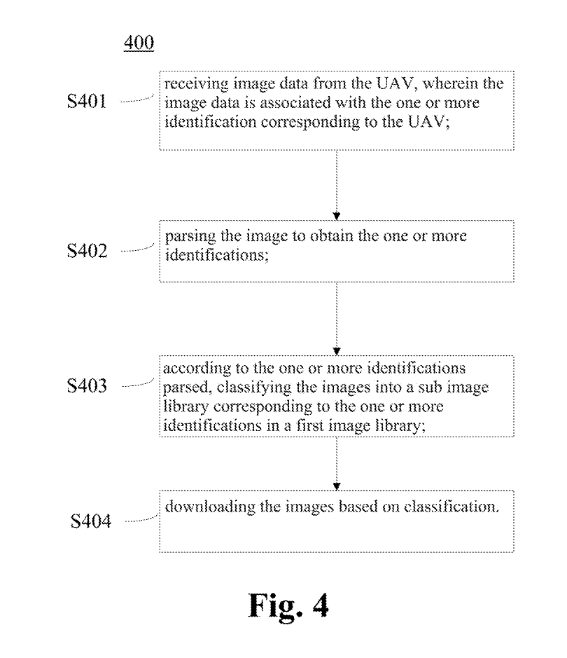

FIG. 4 is a flow chart of the image processing method 400 for the UAV according to a third preferred embodiment of the present invention. As shown in FIG. 4, steps of S401, S402 and S403 are respectively similar to the steps of the S301, S302 and S303 in the FIG. 3, which are not described herein again.

Step S404, downloading the images based on the classification by a user. According to a preferred embodiment of the present invention, the user can download the image data based on the classification of the images according to the one or more identifications mentioned above. According to a preferred embodiment of the present invention, the user can select one or more sub image libraries in the first image library for bulk download. According to a preferred embodiment of the present invention, the user can select a single image for loading. Loaded images can be stored in a corresponding sub image library of a second image library. In a preferred embodiment, the second image library is a downloaded image library. The first image library is separated with the second image library, so as to avoid confusing downloaded images and un-downloaded images. According to a preferred embodiment of the preset invention, the second image library also comprises one or more sub image libraries; wherein a classification manner of the sub image libraries are identical or similar to the first image library. According to a preferred embodiment of the present invention, the loaded images are stored in a corresponding sub image library of the second image library according to the identification thereof. According to another preferred embodiment of the present invention, the loaded images are stored in a corresponding sub image library of the second image library based on the mapping relationship of the sub image library of the first image library to which they belongs and the sub image library of the second image library.

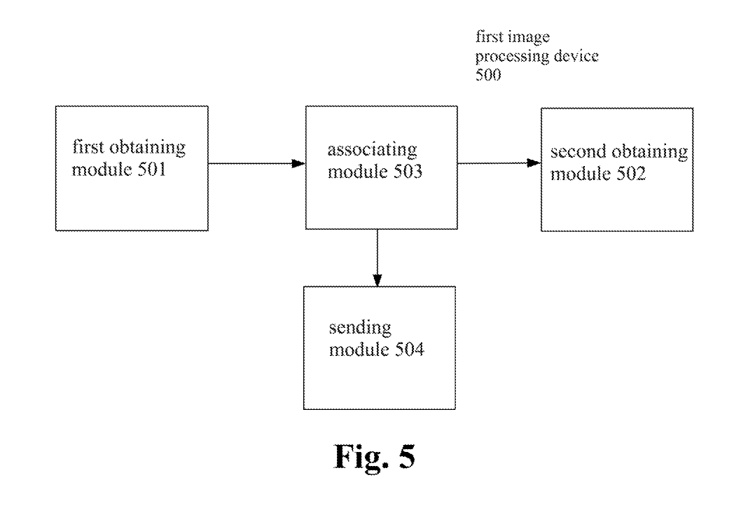

FIG. 5 is a block diagram of a first image processing device 500 for the UAV according to the first preferred embodiment of the present invention. The image processing device 500 comprises: a first obtaining module 501, a second obtaining module 502, an associating module 503 and a sending module 504; wherein the first obtaining module 501 is configured to obtain image data; the second obtaining module 502 is configured to obtain one or more identifications related to an unmanned aerial vehicle (UAV) when the image data is obtained; the associating module 503 is configured to associating the one or more identifications with the image data; and the sending module 504 is configured to send the image data associating with the one or more identifications to a ground terminal. Operations of the image processing device 500 can refer to the steps of the method illustrated in the FIGS. 2 and 3 mentioned above.

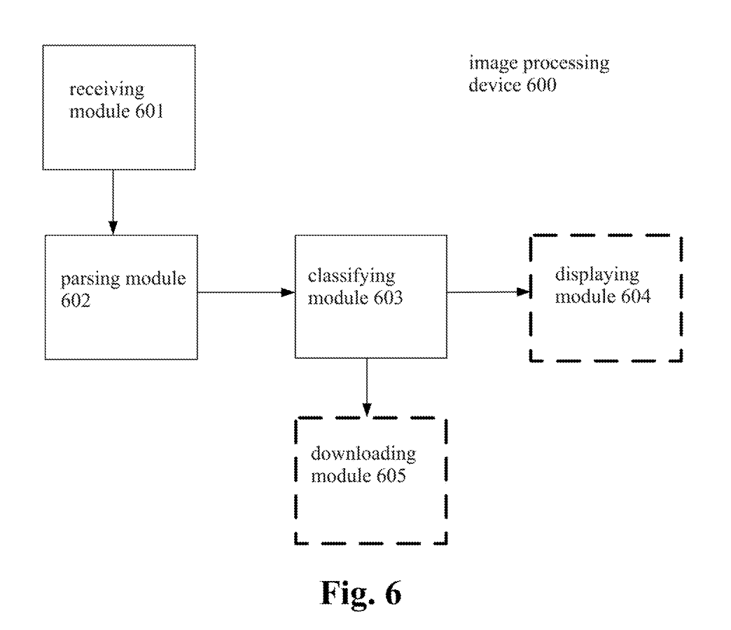

FIG. 6 is a block diagram of a second image processing device 600 the UAV according to the second preferred embodiment of the present invention. The image processing device 600 comprises: a receiving module 601, a parsing module 602, a classifying module 603, a displaying module 604 and a downloading module 605; wherein the receiving module 601 is configured to receive image data from an unmanned aerial vehicle (UAV), the image data is associating with one or more identifications related to the UAV; the parsing module 602 is configured to parse the image data to obtain one or more identifications; the classifying module 603 is configured to classify images into a sub image library corresponding to the one or more identifications in the first image library according to the one or more identifications parsed; the displaying module 604 is configured to display the images based on classification and other information comprising flight routing, map weather; and the downloading module 605 is configured to download the images based on the classification. Operations of each unit of the image processing device 600 can refer to the steps in the method illustrated in the FIGS. 2-4 mentioned above.

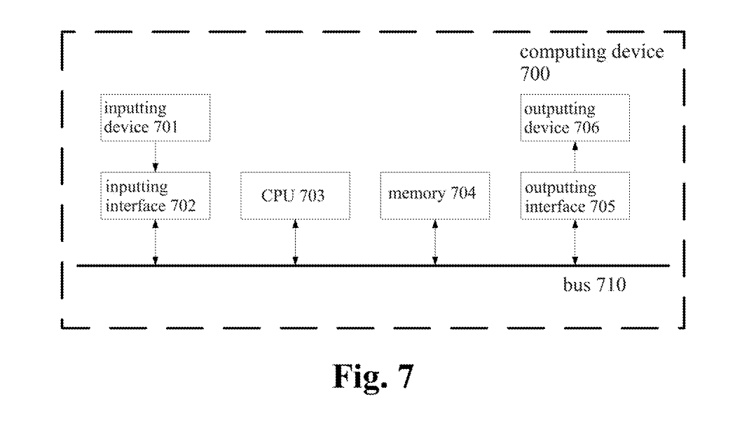

At least a portion of the first image processing device 500 for the UAV and the second image processing device 600 for the UAV can be implemented by a computing device. FIG. 7 is an exemplary structural schematic view of a hardware architecture of a computing device capable of implementing at least one portion of the image processing method and device for the UAV according to a preferred embodiment of the present invention. As shown in FIG. 7, the computing device 700 comprises: an inputting device 701, an inputting interface 702, a central processing unit (CPU) 703, a memory 704, an outputting interface 705 and an outputting device 706; wherein the an inputting interface 702, the CPU 703, the memory 704 and outputting interface 705 are connected with each other via a bus 710; the inputting device 701 and the outputting device 706 are respectively connected with the bus 710 via the inputting interface 702 and the outputting interface 705, so as to connecting with other components of the computing device 700. For example, the inputting device 701 receives input information from outside and transmits the input information to the CPU 703 via the inputting interface 702; the CPU 703 processes the input information based on a computer-executable instruction stored in the memory 704 to generate output information; the output information is computer-executable instruction stored in the memory 704; then the output information is transmitted to the outputting device 706 via the outputting interface 705; the outputting device 706 outputs the output information out of the computing device 700.

In other words, the first image processing device 500 for the UAV and the second image processing device 600 for the UAV shown in the FIGS. 5 and 6 can also be implemented as the memory stored with the computer-executable instruction and a processor; wherein the processor is capable of performing the image processing method for the UAV illustrated in the FIGS. 2-4 while executing the computer-executable instruction.

One of ordinary skills in the art may be aware that the units and algorithm steps of each example described in conjunction with the embodiments disclosed herein is capable of being implemented by electronic hardware, computer software, or a combination of the two. In order to clearly describe interchangeability of the hardware and the software, the elements and steps of each preferred embodiments are generally illustrated in terms of functions as mentioned above. Whether these functions are implemented by hardware or software depends on the specific application and design constraints of the technical solutions. One skilled in the arts can implement the functions mentioned above in varying ways for each particular application, but such implementation cannot be considered as out of the scope of this disclosure.

Those skilled in the art may clearly understand that, for the convenience and simplicity of the description, reference may be made to corresponding processes in the method embodiments mentioned above, and the specific working principle of the system, device and unit mentioned above are not described in detail herein again.

In the several embodiments provided in the present invention, it should be understood that the disclosed system, device, and method can be implemented in other manners. For example, the device embodiments described above are merely exemplary. For example, the unit division is merely logical function division and other division manners are permissible in actual implementation. For example, multiple units or components may be combined or integrated into another system, or some features can be ignored or not executed. In addition, the mutual coupling or direct coupling or communication connection shown or discussed may be indirect coupling or communication connection through some interfaces, devices or units, and may also be electrical, mechanical or other forms of connection.

The units described as separate components may be or may not be physically separated. The displaying components may be or may not be physical units, that is, may be located in one place or may also be distributed to multiple network units. Some or all of the units may be selected according to actual needs to achieve the objectives of the solutions in the embodiments disclosed in the present application.

The descriptions mentioned above are only preferred embodiments of the present disclosure; however, the protection scope of the present disclosure is not limited thereto. Anyone skilled in the art can easily think of various equivalent modifications or replacements, and all these modifications or replacements should be covered within the protection scope of the present disclosure. Thus, the protection scope of the present disclosure should be subject to the protection scope of the claims.

What is claimed is:

1. An image processing method for an unmanned aerial vehicle (UAV), comprising steps of:
receiving image data from the UAV, wherein the image data is associated with one or more identifications related to the UAV;
parsing the image data to obtain the one or more identifications; and
classifying images into a sub image library corresponding to the one or more identifications of a first image library according to the one or more identifications parsed.

2. The image processing method, as recited in claim 1, wherein the step of parsing the image data to obtain the one or more identifications comprises at least one step of:
obtaining the one or more identifications from a preset position of the image data;
obtaining the one or more identifications from a file associated with the image;
obtaining the one or more identifications associating with the image data from database corresponding to the image data; and
obtaining the one or more identifications from an extended attributes corresponding to the image data.

3. The image processing method, as recited in claim 1, wherein the one or more identifications comprise: a time point, a waypoint, a flying height, a flying posture, a flying speed, a distance from a destination and a flight abnormality indicator.

4. The image processing method, as recited in claim 3, wherein the flight abnormality indicator comprises a flight beginning abnormality indicator and a flight end abnormality indicator.

5. The image processing method, as recited in claim 1, wherein the step classifying images into the sub image library corresponding to the one or more identifications of the first image library according to the one or more identifications parsed comprises steps of:
determining whether the one or more identifications conform to preset classification properties;
if the one or more identifications conform to the classification properties, the images are classified into a sub image library of the first image library corresponding to the classification properties.

6. The image processing method, as recited in claim 1, further comprising a step of: downloading the images based on the classifying.

7. The image processing method, as recited in claim 6, wherein after the step of downloading the images based on the classifying, the image processing method further comprises a step of: storing images downloaded into a sub image library corresponded to a second image library; wherein the sub image library corresponded to the second image library is associated with the sub image library of the first image library to which the images downloaded belongs.

8. An image processing method for an unmanned aerial vehicle (UAV), comprising steps of:
obtaining image data;
obtaining one or more identifications related to the UAV when the image data is obtained;
associating the one or more identifications with the image data; and
sending the image data associated with the one or more identifications to a ground terminal.

9. The image processing method, as recited in claim 8, wherein the step of obtaining the image data comprises a step of: taking images by a camera on the UAV and obtaining the image data corresponded.

10. The image processing method, as recited in claim 8, wherein the step of obtaining the image data comprises a step of: obtaining the image data by communicating with other aircraft or the ground terminal by the UAV.

11. The image processing method, as recited in claim 8, wherein the one or more identifications comprise: a time point, a waypoint, a flying height, a flying posture, a flying speed, a distance from a destination and a flight abnormality indicator.

12. The image processing method, as recited in claim 11, wherein the flight abnormality indicator comprises a flight beginning abnormality indicator and a flight end abnormality indicator.

13. The image processing method, as recited in claim 8, wherein the step of associating the one or more identifications with the image data comprises one step selected from the group consisting of:
writing the one or more identifications into a preset position of the image data;
storing the one or more identifications to a file associated with the image data;
storing the one or more identifications in database corresponding to the image data; and
writing the one or more identifications into extended attributes corresponding to the image data.

14. An image processing device for an unmanned aerial vehicle (UAV), comprising:
a receiving module configured to receive image data from the UAV, wherein the image data is associating with one or more identifications related to the UAV;
a parsing module configured to parse the image data to obtain the one or more identifications; and
a classifying module configured to classify images into a sub image library corresponding to the one or more identifications in a first image library according to the one or more identifications parsed.

15. The image processing device, as recited in claim 14, wherein the one or more identifications is obtained from a preset position of the image data; a file associated with the image data; database corresponding to the image data; or extended attributes corresponding to the image data.

16. The image processing device, as recited in claim 14, wherein the one or more identifications comprise: a time point, a waypoint, a flying height, a flying posture, a flying speed, a distance from a destination and a flight abnormality indicator.

17. The image processing device, as recited in claim 16, wherein the flight abnormality indicator comprises a flight beginning abnormality indicator and a flight end abnormality indicator.

18. The image processing device, as recited in claim 14, wherein the classifying module is further configured to determine whether the one or more identifications conform to preset classification properties; and
if the one or more identifications conform to the classification properties, classify the images into a sub image library of the first image library corresponding to the classification properties.

19. The image processing device, as recited in claim 14, further comprising: a downloading module configured to download the images based on classification.

20. The image processing device, as recited in claim 19, wherein after the downloading module downloads the images based on the classification, the downloading module is configured to store images downloaded into a sub image library corresponded to a second image library; wherein the sub image library corresponded to the second image library is associated with the sub image library of the first image library to which the images downloaded belongs.
